(19) United States
(12) Patent Application Publication
(10) Pub. No.: US 2026/0235051 A1
(43) Pub. Date: Aug. 13, 2026

(54) STEAM TURBINE EXHAUST CHAMBER, AND STEAM TURBINE

(71) Applicant: MITSUBISHI HEAVY INDUSTRIES, LTD., Tokyo (JP)

(72) Inventors: Soichiro Tabata, Tokyo (JP); Kiyoshi Segawa, Tokyo (JP)

(73) Assignee: MITSUBISHI HEAVY INDUSTRIES, LTD., Tokyo (JP)

(21) Appl. No.: 19/154,448

(22) PCT Filed: Mar. 13, 2024
(86) PCT No.: PCT/JP2024/009696

§ 371 Date: Aug. 7, 2025

(30) Foreign Application Priority Data
Mar. 15, 2023 (JP) 2023-040201

(51) Int. Cl. F01D 25/30

(52) U.S. Cl. CPC F01D 25/30

(57) ABSTRACT

A steam turbine exhaust chamber according to one embodiment comprises a diffuser that forms a diffuser space, and an exhaust casing that forms an exhaust space. The diffuser has an outer diffuser defining a radially outer edge of the diffuser space, and an inner diffuser defining a radially inner edge of the diffuser space. Regarding a first flow guide, for example, the axial distance from an axis downstream-side end of a blade end of a final stage moving blade to an axis downstream-side end section of the first flow guide is 20% to 45% of the blade height of the final stage moving blade.

### TECHNICAL FIELD

The present disclosure relates to a steam turbine exhaust hood and a steam turbine.

The present application claims priority based on Japanese Patent Application No. 2023-040201 filed in Japan on Mar. 15, 2023, the contents of which are incorporated herein by reference.

### BACKGROUND ART

Steam from a turbine casing of a steam turbine is usually discharged from the steam turbine via an exhaust hood. In the exhaust hood, a fluid loss occurs due to properties of a steam flow, a shape of an internal structure, or the like. Therefore, a shape of a diffuser forming a diffuser flow path of the exhaust hood is important.

For example, in the steam turbine described in PTL 1, an end portion of a tip flow guide upper half portion extends toward a downstream side, so that a diffuser length is longer than that in the related art, and a turbine exhaust loss is reduced (refer to PTL 1).

### CITATION LIST

### Patent Literature

[PTL 1] Japanese Unexamined Patent Application Publication No. 2004-353629

### SUMMARY OF INVENTION

### Technical Problem

In an exhaust hood, a pressure of steam flowing out from a last rotor blade row is restored. As a pressure recovery amount increases, the pressure of the steam is lowered immediately after the steam flows out from the last rotor blade row, thereby improving turbine efficiency. Therefore, it is desirable to increase the pressure. recovery amount by reducing a pressure loss of the steam flowing inside the exhaust hood.

In recent years, due to a shift to renewable energy such as wind power and solar power, there has been a demand for a flexible operation for absorbing load fluctuations in a thermal power plant. In a case where such flexible operation is performed, it is necessary to perform operation other than the design point, that is, operation other than rated operation. When the operation other than the rated operation is performed, delamination or a backflow occurs inside the exhaust hood, and the pressure loss increases inside the exhaust hood, thereby decreasing the pressure recovery amount.

In view of the above circumstances, an object of at least one embodiment of the present disclosure is to provide an exhaust hood of a steam turbine capable of increasing a pressure recovery amount by reducing a pressure loss of steam not only during a rated operation but also during a partial load operation, and a steam turbine including the exhaust hood.

### Solution to Problem

(1) An exhaust hood of a steam turbine according to at least one embodiment of the present disclosure, includes:
a diffuser that forms a diffuser space into which steam flowing out from a last rotor blade row of a steam turbine rotor rotating around an axis flows and which has an annular shape with respect to the axis and that gradually expands outward in a radial direction with respect to the axis toward an axial downstream side; and
an exhaust casing that has an exhaust port opening outward in the radial direction and that forms an exhaust space communicating with the diffuser space and expanding in a circumferential direction with respect to the axis to guide the steam flowing in from the diffuser space to the exhaust port,
in which the diffuser includes
   an outer diffuser having an annular shape in a cross section perpendicular to the axis, gradually expanding outward in the radial direction toward the axial downstream side, and defining an edge of the diffuser space on a radial outer side, and
   an inner diffuser having an annular shape in a cross section perpendicular to the axis, gradually expanding outward in the radial direction toward the axial downstream side, and defining an edge of the diffuser space on a radial inner side with respect to the axis,
the outer diffuser includes
   a first flow guide extending toward the axial downstream side from a position facing a blade end of a last stage rotor blade constituting a last rotor blade row, and
   a second flow guide extending outward in the radial direction from the first flow guide at an angle different from the first flow guide, and
the first flow guide satisfies at least one condition selected from the group consisting of
   an axial distance with respect to the axis from an end portion of the blade end of the last stage rotor blade on the axial downstream side to the end portion of the first flow guide on the axial downstream side is 20% or more and 45% or less of a blade height of the last stage rotor blade,
   an axial distance from the end portion of the first flow guide on the axial downstream side to a downstream wall surface defining an edge of the exhaust space on the axial downstream side in the exhaust casing is 100% or more and 150% or less of the blade height,
   a radial distance with respect to the axis from the end portion of the first flow guide on the axial upstream side to the end portion of the first flow guide on the axial downstream side is 200% or more and 300% or less of a radial distance from an intersection position at which a perpendicular line extending in a direction perpendicular to the axial direction from the end portion of the first flow guide on the axial downstream side as a start point intersects the inner diffuser to an end portion of the inner diffuser on the axial upstream side, and
   an area of a cross section of the diffuser space perpendicular to the axis at an end portion of the first flow guide on the axial downstream side is 110% or more and 150% or less of an area of a cross section of the diffuser space perpendicular to the axis at an outlet of a last rotor blade row.
(2) A steam turbine according to at least one embodiment of the present disclosure includes:
exhaust hood of a steam turbine according to the configuration of (1) above; and
a steam turbine rotor.

### Advantageous Effects of Invention

According to at least one embodiment of the present disclosure, it is possible to provide an exhaust hood of a steam turbine capable of reducing a pressure loss of steam not only during a rated operation but also during a partial load operation and increasing a pressure recovery amount, and a steam turbine including the exhaust hood.

### BRIEF DESCRIPTION OF DRAWINGS

FIG. 1 is a schematic view schematically showing a cross section of a steam turbine according to one embodiment along an axial direction.

FIG. 2 is a schematic view schematically showing a cross section of a steam turbine according to another embodiment along an axial direction.

FIG. 3 is an enlarged view of a main portion of a steam turbine according to the embodiment shown in FIG. 1.

FIG. 4 is an enlarged view of a main portion of a steam turbine 1 according to another embodiment shown in FIG. 2.

FIG. 5 is a diagram schematically showing a flow of steam when a rated operation is performed in the steam turbine shown in FIGS. 1 and 3.

FIG. 6 is a diagram schematically showing a flow of steam when a partial load operation is performed in the steam turbine shown in FIGS. 1 and 3.

FIG. 7 is a diagram for describing conditions (a) and (b).

FIG. 8 is a diagram for describing a condition (c).

FIG. 9 is a diagram for describing a condition (d).

FIG. 10 is a diagram for describing an angle formed by a line segment connecting an upstream-side intersection position and an end portion of a first flow guide on an axial downstream side with respect to the axial direction and an angle formed by a line segment connecting an end portion of an inner diffuser on an axial upstream side and a downstream-side intersection position with respect to the axial direction.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven portion or a chamfered portion within a range where the same effect can be obtained.

In addition, expressions of “being provided with”, “being equipped with”, “including”, or “having” one component are not exclusive expressions excluding the presence of other components.

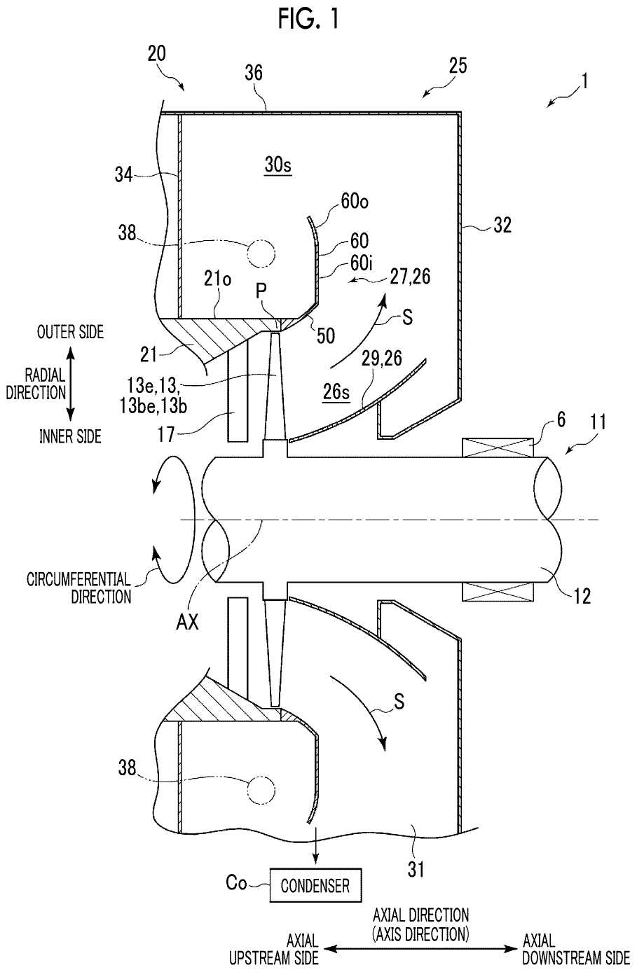

FIG. 1 is a schematic diagram schematically showing a cross section of a steam turbine 1 according to one embodiment along an axial direction.

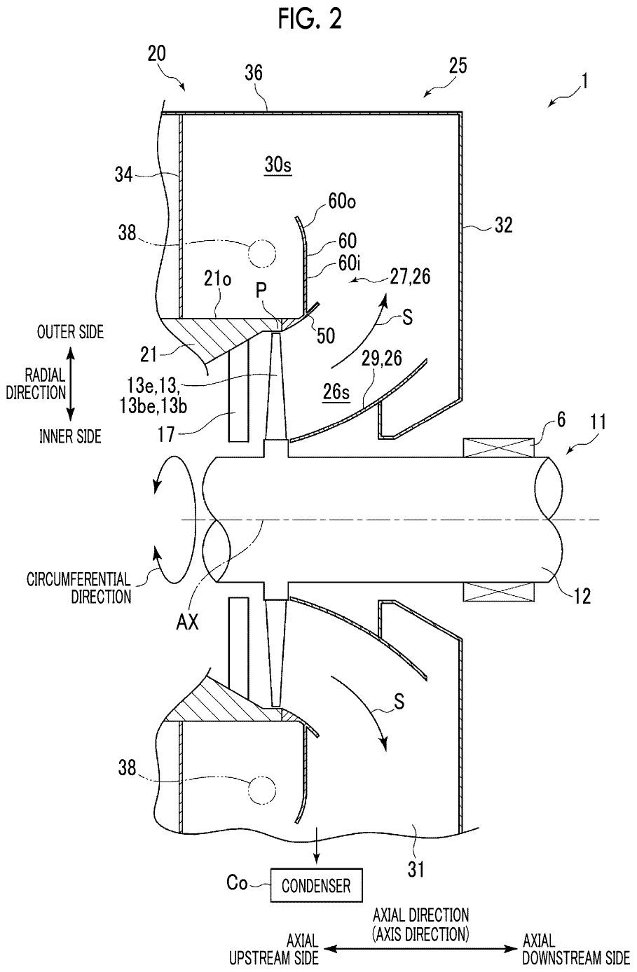

FIG. 2 is a schematic diagram schematically showing a cross section of the steam turbine 1 according to another embodiment along the axial direction.

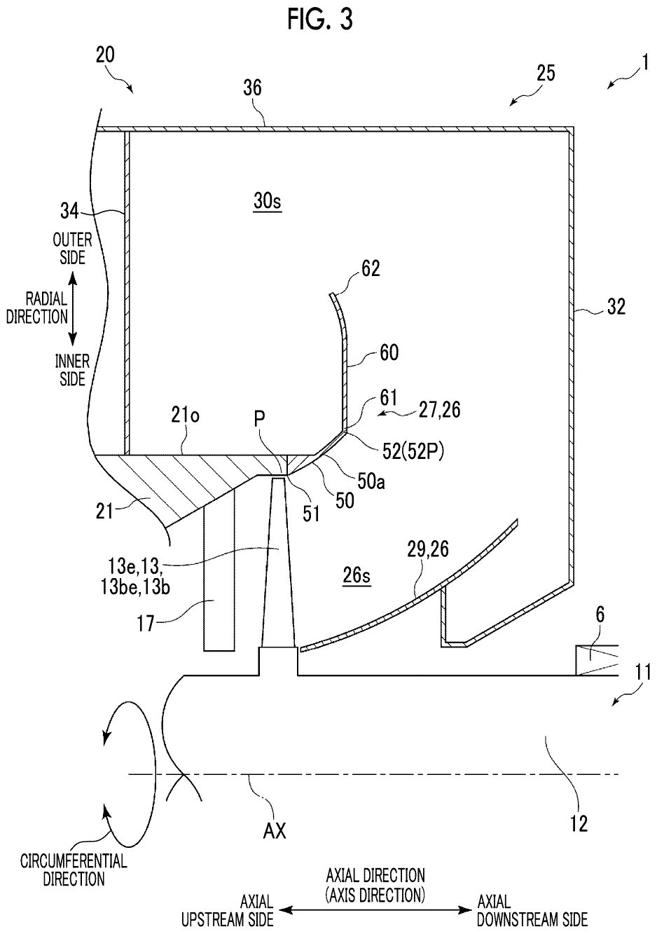

FIG. 3 is an enlarged view of a main portion of a steam turbine 1 according to one embodiment shown in FIG. 1.

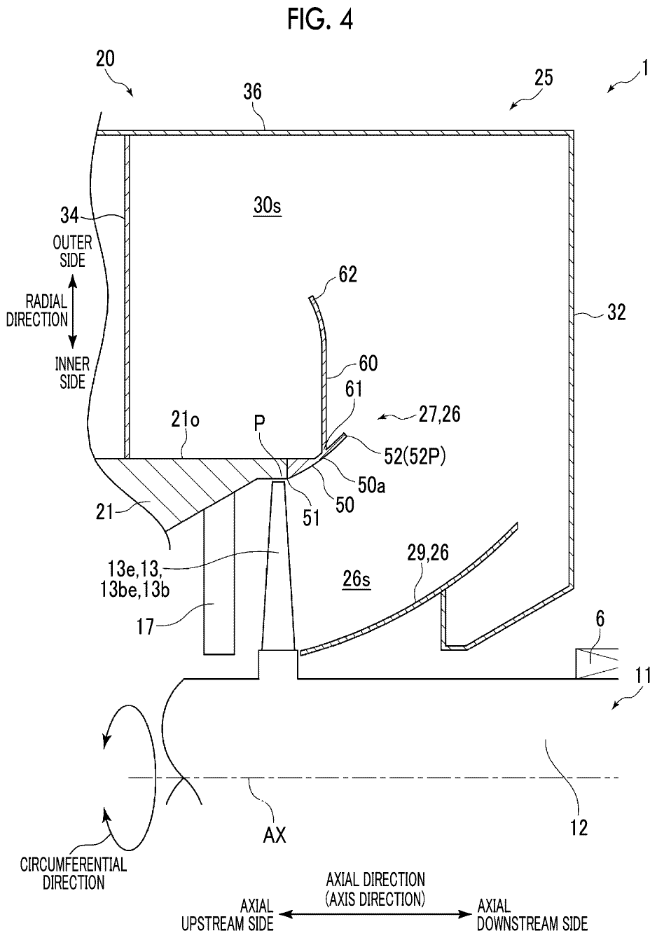

FIG. 4 is an enlarged view of a main portion of a steam turbine 1 according to another embodiment shown in FIG. 2.

The steam turbine 1 shown in FIGS. 1 to 4 is an axial flow turbine.

As shown in FIGS. 1 to 4, a steam turbine 1 according to some embodiments includes a turbine rotor (steam turbine rotor) 11 that is rotatably supported by a bearing 6 and that is rotatable around an axis AX, a casing 20 that covers the turbine rotor 11, and a plurality of stator vane rows 17 that are fixed to the casing 20. In the following, a direction in which the axis AX extends will be referred to as an axial direction or simply an axis direction, a circumferential direction around the axis AX will be referred to as simply a circumferential direction, and a radial direction with respect to the axis AX will be referred to as a radial direction. Further, a direction approaching the axis AX in the radial direction will be referred to as a radial inner side, and a direction opposite thereto will be referred to as a radial outer side.

The turbine rotor 11 includes a rotor shaft 12 extending in the axial direction around the axis AX, and a plurality of rotor blade rows 13 attached to the rotor shaft 12. The turbine rotor 11 is supported to be rotatable around the axis AX by the bearing 6. The plurality of rotor blade rows 13 are arranged in the axial direction. Each of the rotor blade rows 13 is composed of a plurality of rotor blades 13b arranged in the circumferential direction.

The casing 20 includes an inner casing 21 and an exhaust hood 25. The inner casing 21 forms a substantially conical space around the axis AX, and covers an outer periphery of the turbine rotor 11. The plurality of rotor blade rows 13 of the turbine rotor 11 are disposed in the conical space. The plurality of stator vane rows 17 are aligned along the axial direction, and are disposed inside the conical space. Each of the plurality of stator vane rows 17 is disposed on an axial upstream side of any one rotor blade row 13 of the plurality of rotor blade rows 13. As described above, the plurality of stator vane rows 17 are fixed to the inner casing 21.

The exhaust hood 25 includes a diffuser 26 and an exhaust casing 30.

The diffuser 26 forms a diffuser space 26s that is anular with respect to the axis AX and that gradually expands outward in the radial direction toward an axial downstream side. Steam S flowing out from a last rotor blade row 13e of the turbine rotor 11 flows into the diffuser space 26s. The last rotor blade row 13e is a rotor blade row 13 that is disposed on the most axial downstream side among the plurality of rotor blade rows 13. The plurality of rotor blades 13b forming the last rotor blade row 13e are referred to as last stage rotor blades 13be. The diffuser 26 has an outer diffuser 27 (or a steam guide and a flow guide) that defines an edge of the diffuser space 26s on the radial outer side, and an inner diffuser 29 (or a bearing cone) that defines an edge of the diffuser space 26s on the radial inner side. The outer diffuser 27 has an annular cross section perpendicular to the axis AX, and gradually expands outward in the radial direction toward the axial downstream side. The inner diffuser 29 also has an annular cross section perpendicular to the axis AX, and gradually expands outward in the radial direction toward the axial downstream side. The outer diffuser 27 is connected to the inner casing 21.

The exhaust casing 30 has an exhaust port 31. The exhaust port 31 is open from the inside toward the radial outer side and in a vertically downward direction. A condenser Co for converting the steam S back to water is connected to the exhaust port 31. Therefore, the steam turbine of the present embodiment is a downward exhaust type condensing steam turbine. In addition, since the steam turbine 1 of the present embodiment is a downward exhaust type condensing steam turbine, a lower side of the drawing sheet in FIGS. 1 and 2 is a vertically lower side, and an upper side of the drawing sheet in FIGS. 1 and 2 is a vertically upper side.

The exhaust casing 30 forms an exhaust space 30s communicating with the diffuser 26. The exhaust space 30s extends in the circumferential direction with respect to the axis AX on an outer periphery of the diffuser 26, and leads the steam S that has flowed in from the diffuser space 26s to the discharge port 31. The exhaust casing 30 has a casing downstream-side end plate 32, a casing upstream-side end plate 34, and a casing outer peripheral plate 36.

The casing downstream-side end plate 32 defines an edge of the exhaust space 30s on the axial downstream side. The casing downstream-side end plate 32 extends in a direction including a radial component and in the circumferential direction, and is substantially perpendicular to the axis AX. A portion above the axis AX in the casing downstream-side end plate 32 has a substantially semicircular shape. On the other hand, a portion below the axis AX in the casing downstream-side end plate 32 has a substantially rectangular shape. However, the casing downstream-side end plate 32 has a circular opening formed around the axis AX. An edge of the circular opening forms an edge on the radial inner side of the casing downstream-side end plate 32. A lower edge of the casing downstream-side end plate 32 forms a portion of an edge of the exhaust port 31.

The casing outer peripheral plate 36 defines an edge on the radial outer side of the exhaust space 30s. The casing outer peripheral plate 36 is connected to an edge of the casing downstream-side end plate 32 on the radial outer side, extends in the axial direction, and extends in the circumferential direction around the axis AX. The casing outer peripheral plate 36 has a semi-cylindrical shape on the upper side. An edge of the casing outer peripheral plate 36 on the axial downstream side is connected to the casing downstream-side end plate 32. In addition, a lower edge on the casing outer peripheral plate 36 forms a portion of an edge of the exhaust port 31.

The casing upstream-side end plate 34 defines an edge on the axial upstream side of the exhaust space 30s. The casing upstream-side end plate 34 is disposed axially upstream of the diffuser 26. The casing upstream-side end plate 34 extends outward in the radial direction from an outer peripheral surface 210 of the inner casing 21. The casing upstream-side end plate 34 is substantially perpendicular to the axis AX. Therefore, the casing upstream-side end plate 34 faces the casing downstream-side end plate 32 at an interval therebetween in the axial direction. A lower edge of the casing upstream-side end plate 34 forms a portion of the edge of the exhaust port 31. In an edge of the casing upstream-side end plate 34 on the radial outer side, a portion excluding a portion forming the edge of the exhaust port 31 is connected to the casing outer peripheral plate 36.

As shown in FIGS. 1 and 2, the steam turbine 1 according to some embodiments is provided with a spray pipe 38 that is a pipe through which fluid (water) for cooling the rotor blades 13b can flow. The spray pipe 38 through which fluid flows is disposed in an annular shape in a region that is on the radial outer side of a first flow guide 50 and on the radial inner side of an end portion 62 of a second flow guide 60 on the radial outer side, the region being within a range in the axial direction from an end portion 51 of the first flow guide 50 on the axial upstream side to the end portion 52 of the first flow guide 50 on the axial downstream side.

In this manner, a pipe through which fluid for cooling the rotor blade flows can be disposed while suppressing the influence on the flow of the steam.

In addition, the description of the spray pipe 38 is omitted in each of the drawings after FIG. 3.

### Outer Diffuser 27

The outer diffuser 27 according to some embodiments includes a first flow guide 50 extending toward the axial downstream side from a position P facing a blade end 13t of a last stage rotor blade 13be constituting a last rotor blade row 13e, and a second flow guide 60 extending outward in the radial direction from the first flow guide 50 at an angle different from the first flow guide 50.

### First Flow Guide 50

As shown clearly in FIGS. 3 and 4, the first flow guide 50 according to some embodiments is a member having an end portion 51 on the axial upstream side and an end portion 52 on the axial downstream side, and having an annular cross section perpendicular to the axis AX, and is formed to gradually expand outward in the radial direction toward the axial downstream side. The end portion 51 of the first flow guide 50 on the axial upstream side is connected to the inner casing 21.

In the first flow guide 50 according to some embodiments, the shape of the cross section of the first flow guide 50 appearing on an imaginary plane (for example, a plane in FIGS. 1 to 4) extending in the axial direction and the radial direction has a curved surface that is convex inward in the radial direction. The first flow guide 50 according to some embodiments may have a conical surface that gradually expands outward in the radial direction toward the axial downstream side at least in a part thereof.

In the first flow guide 50 according to some embodiments, the end portion 52 of the first flow guide 50 on the axial downstream side is a separation point 52P formed such that a flow of the steam S flowing through the diffuser space 26s separates from the end portion 52 on the axial downstream side.

For example, in the example shown in FIG. 3, an end portion 61 of the second flow guide 60, which will be described later, on the radial inner side is connected to the end portion 52 of the first flow guide 50 on the axial downstream side. However, an angle difference between the extending direction of the first flow guide 50 extending toward the axial downstream side and the radial outer side of the first flow guide 50 in the vicinity of the end portion 52 of the first flow guide 50 on the axial downstream side and the extending direction of the second flow guide 60 extending mainly toward the radial inner side in the vicinity of the end portion 61 on the radial inner side of the second flow guide 60 is relatively large. In addition, the shape of the surface of the outer diffuser 27, which faces the diffuser space 26s, appearing on an imaginary plane (for example, a plane in FIGS. 1 to 4) extending in the axial direction and the radial direction, changes relatively steeply from the vicinity of the end portion 52 of the first flow guide 50 on the axial downstream side to the vicinity of the end portion 61 of the second flow guide 60 on the radial inner side.

By having such a shape, in the first flow guide 50 according to some embodiments, the end portion 52 of the first flow guide 50 on the axial downstream side is a separation point 52P formed such that a flow of the steam S flowing through the diffuser space 26s separates from the end portion 52 on the axial downstream side. The separation point 52P faces the diffuser space 26s.

In addition, since the flow of the steam S flowing through the diffuser space 26s is formed to be substantially separated from the end portion 52 on the axial downstream side, for example, an R portion having a curvature radius of a certain size may be formed from the vicinity of the end portion 52 on the axial downstream side of the first flow guide 50 to the vicinity of the end portion 61 on the radial inner side of the second flow guide 60.

### Second Flow Guide 60

The second flow guide 60 according to some embodiments is a member that has an end portion 61 on the radial inner side and an end portion 62 on the radial outer side, has an annular cross section perpendicular to the axis AX, and extends mainly in the radial direction.

In the second flow guide 60 shown in FIGS. 1 and 3, as shown clearly in FIG. 3, the end portion 61 on the radial inner side is connected to the first flow guide 50 at the end portion 52 of the first flow guide 50 on the axial downstream side.

In the second flow guide 60 shown in FIGS. 2 and 4, as shown clearly in FIG. 4, the end portion 61 on the radial inner side is connected to the first flow guide 50 axially upstream of the end portion 52 of the first flow guide 50 on the axial downstream side.

In the second flow guide 60 according to some embodiments, a region 60i on the radial inner side in the second flow guide extends in a direction perpendicular to the axis AX.

In the second flow guide 60 according to some embodiments, a region 60o on the radial outer side in the second flow guide is curved toward the axial upstream side as the region 60o extends outward in the radial direction.

That is, the second flow guide 60 is located at an axial position of the end portion 61 on the radial inner side and is located on the axial upstream side with respect to the axial position.

(Regarding Improvement in Efficiency During Partial Load Operation of Steam Turbine 1) In the steam turbine of the related art, during the partial load operation, there is a problem in that separation or backflow occurs in the exhaust hood, a pressure loss in the exhaust hood increases, and a pressure recovery amount decreases.

As a result of intensive studies by the inventors, it has been found that, by configuring the first flow guide 50 to satisfy at least one of four conditions (a) to (d) to be described later, it is possible to suppress the decrease in efficiency of the steam turbine 1 during partial load operation, as compared with conventional steam turbines, while maintaining the efficiency of the steam turbine 1 during rated operation.

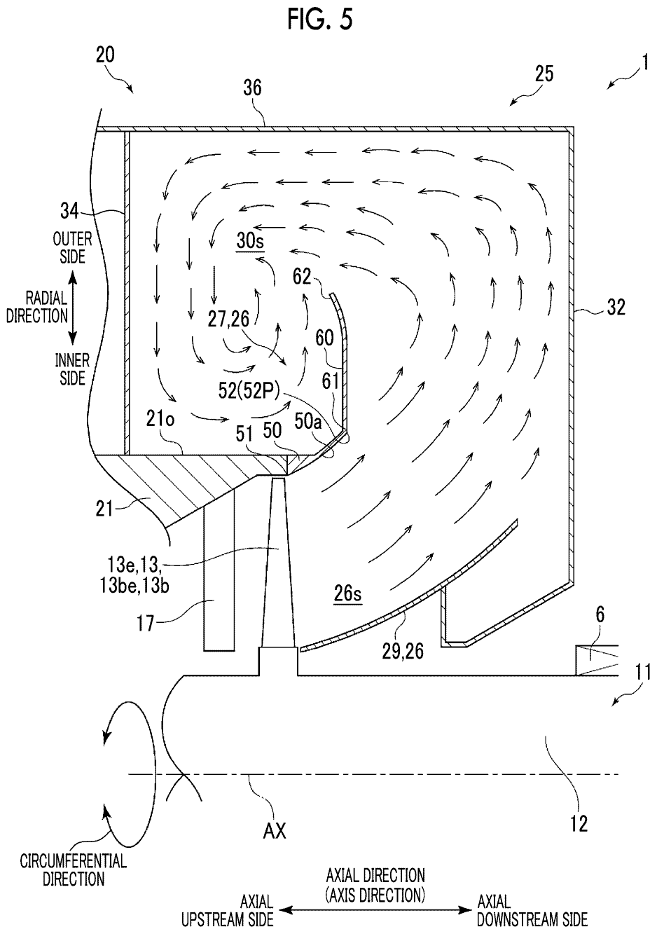

FIG. 5 is a diagram schematically showing a flow of steam S when a rated operation is performed in the steam turbine 1 shown in FIGS. 1 and 3.

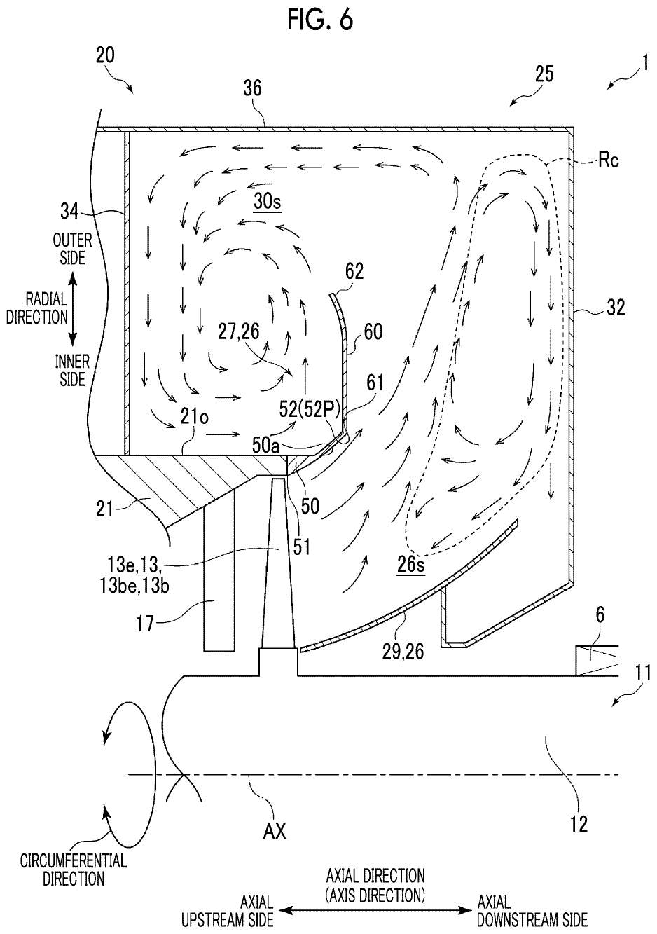

FIG. 6 is a diagram schematically showing a flow of the steam S when the partial load operation is performed in the steam turbine 1 shown in FIGS. 1 and 3.

In FIGS. 5 and 6, the direction of each arrow indicates the direction in which the steam S flows, and the length of each arrow indicates the magnitude of the flow speed of the steam S.

As a result of intensive studies by the inventors, it has been found that, by configuring the first flow guide 50 to satisfy at least one of four conditions (a) to (d) to be described later, during rated operation, as shown in FIG. 5, the main flow of steam S, having separated from the end portion 52 of the first flow guide 50 on the axial downstream side, becomes a free jet-like flow, whereby an effect similar to that of a diffuser located axially downstream of the end portion 52 of the first flow guide 50 on the axial downstream side can be obtained. Accordingly, it has been found that the efficiency of the steam turbine 1 can be maintained during the rated operation.

In addition, as a result of intensive studies by the inventors, it has been found that, by configuring the first flow guide 50 to satisfy at least one of four conditions (a) to (d) to be described later, during the partial load operation, as shown in FIG. 6, the flow of the steam S flowing along a surface 50a of the first flow guide 50 is suppressed from generating a flow having a relatively high flow speed in the vicinity of the surface 50a of the first flow guide 50 due to the Coanda effect. As a result of intensive studies by the inventors, it has been found that when a flow having a relatively high flow speed is generated in the vicinity of the surface 50a of the first flow guide 50 due to the Coanda effect, the exhaust space 30s is divided into a region on the axial upstream side and a region on the axial downstream side with the flow of the steam S as a boundary, and the pressure recovery in the exhaust space 30s is suppressed. Therefore, it has been found that the pressure recovery amount in the exhaust space 30s during the partial load operation can be increased by suppressing the generation of a flow having a relatively high flow speed in the vicinity of the surface 50a of the first flow guide 50 due to the Coanda effect.

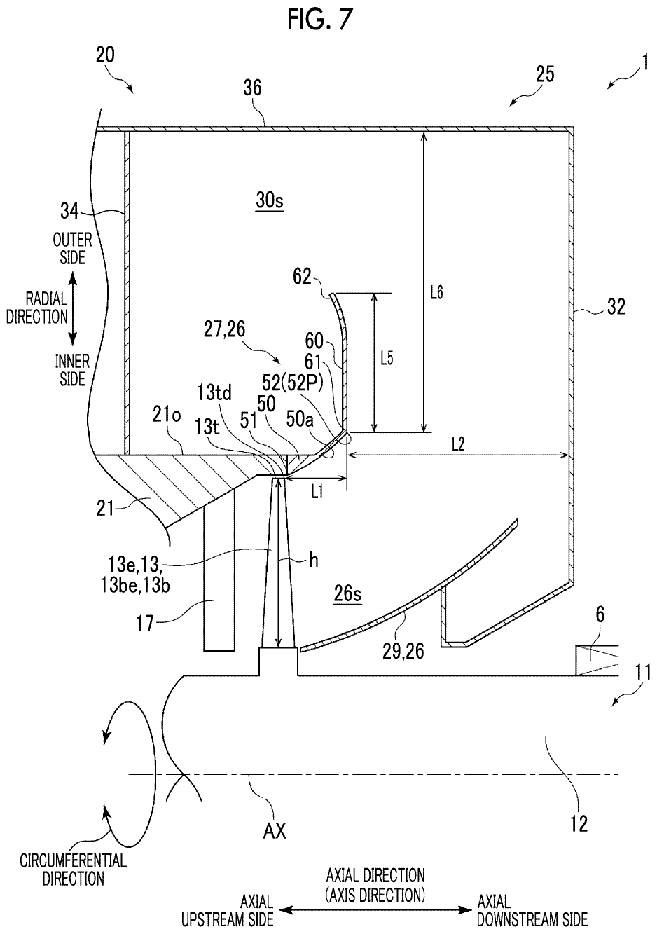

FIG. 7 is a diagram for describing conditions (a) and (b) to be described later.

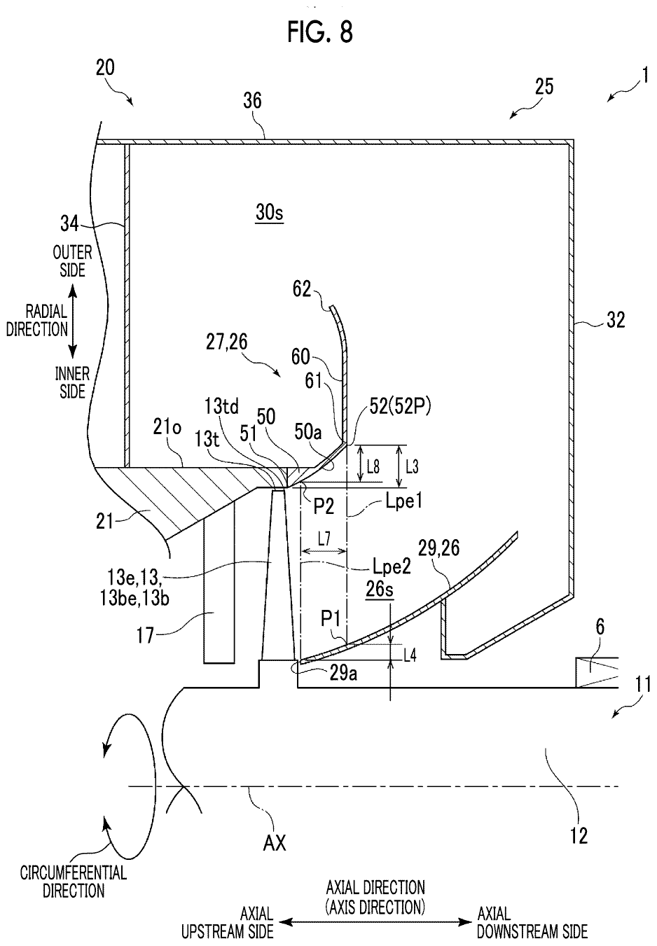

FIG. 8 is a diagram for describing a condition (c) to be described later.

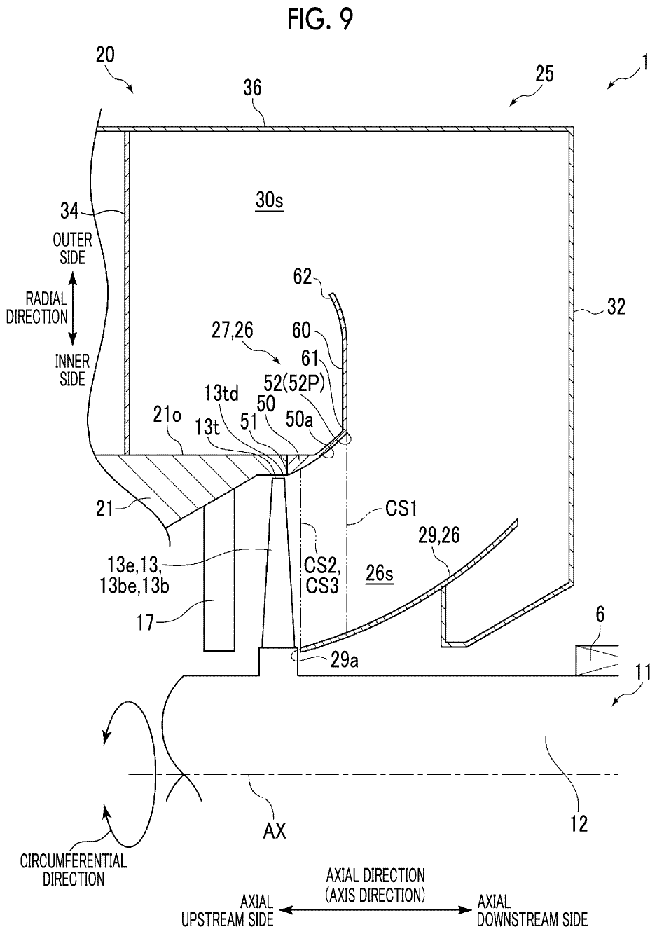

FIG. 9 is a diagram for describing a condition (d) to be described later.

In the first flow guide 50 according to some embodiments shown in FIGS. 1 to 4, four conditions (a) to (d) that are desired to be satisfied are as follows.
(a) An axial distance L1 from an end portion 13td of the blade end 13t of the last stage rotor blade 13be on the axial downstream side to the end portion 52 of the first flow guide 50 on the axial downstream side is 20% or more and 45% or less of a blade height h of the last stage rotor blade 13be.
(b) An axial distance L2 from the end portion 52 of the first flow guide 50 on the axial downstream side to a downstream wall surface (casing downstream-side end plate 32) defining an edge of the exhaust space 30s on the axial downstream side in the exhaust casing 30 is 100% or more and 150% or less of the blade height h.
(c) A radial distance L3 from the end portion 51 of the first flow guide 50 on the axial upstream side to the end portion 52 of the first flow guide 50 on the axial downstream side is 200% or more and 300% or less of a radial distance LA from an intersection position (downstream-side intersection position) PI at which a perpendicular line (downstream-side perpendicular line) Lpel extending in a direction perpendicular to the axial direction from the end portion 52 of the first flow guide 50 on the axial downstream side as a start point intersects the inner diffuser 29 to an end portion 29a of the inner diffuser 29 on the axial upstream side.
(d) An area of an annular cross section CSI of the diffuser space 26s perpendicular to the axis AX at the end portion 52 of the first flow guide 50 on the axial downstream side is 110% or more and 150% or less of an area of an annular cross section CS2 of the diffuser space 26s perpendicular to the axis AX at an outlet of a last rotor blade row 13e.

Therefore, according to the exhaust hood 25 according to some embodiments, the decrease in the efficiency of the steam turbine 1 during the partial load operation can be suppressed while maintaining the efficiency of the steam turbine 1 during the rated operation by the first flow guide 50 having a relatively simple configuration.

In addition, according to the steam turbine 1 including the exhaust hood 25 according to some embodiments, it is possible to suppress a decrease in the efficiency of the steam turbine 1 during partial load operation while maintaining the efficiency of the steam turbine 1 during rated operation.

The exhaust hood 25 according to some embodiments may further have the following features.

For example, in the exhaust hood 25 according to some embodiments, as described above, the shape of the cross section of the first flow guide 50 appearing on an imaginary plane (for example, a plane in FIGS. 1 to 4) extending in the axial direction and the radial direction may have a curved surface that is convex inward the radial direction.

Accordingly, the steam S flowing along the surface 50a of the first flow guide 50 is likely to spread to the radial outer side. Therefore, the pressure loss of the steam S flowing through the diffuser space 26s can be reduced.

For example, in the exhaust hood 25 according to some embodiments, as shown in FIG. 7, a distance L5 from the end portion 61 of the second flow guide 60 on the radial inner side to an end portion 62 of the second flow guide 60 on the radial outer side is 25% or more and 75% or less of a radial distance L6 from the end portion 52 of the first flow guide 50 on the axial downstream side to a radial outer wall surface (casing outer peripheral plate 36) that defines an edge of the exhaust space 30s ou the radial outer side in the exhaust casing 30.

Accordingly, the flow of the steam S that forms a vortex in the exhaust space 30s axially upstream of the second flow guide 60 is less likely to affect the main flow of the steam S flowing along the first flow guide 50. Therefore, the pressure loss inside the exhaust hood 25 can be suppressed.

In the exhaust hood 25 according to some embodiments, the region 60o on the radial outer side in the second flow guide 60 may be curved toward the axial upstream side as the region 60o extends outward in the radial direction.

Accordingly, the flow of the steam S that forms a vortex in the exhaust space 30s axially upstream of the second flow guide 60 is less likely to affect the main flow of the steam S flowing along the first flow guide 50. Therefore, the pressure loss inside the exhaust hood 25 can be suppressed.

In the exhaust hood 25 according to some embodiments, as shown in FIGS. 1 and 3, the end portion 61 of the second flow guide 60 on the radial inner side may be connected to the first flow guide 50 at the end portion 52 of the first flow guide 50 on the axial downstream side.

In this manner, the second flow guide 60 can be connected to the first flow guide 50 while suppressing the influence on the main flow of the steam S separated from the end portion 52 of the first flow guide 50 on the axial downstream side.

In the exhaust hood 25 according to some embodiments, as shown in FIGS. 2 and 4, the end portion 61 of the second flow guide 60 on the radial inner side may be connected to the first flow guide 50 axially upstream of the end portion 52 of the first flow guide 50 on the axial downstream side.

In this manner, the second flow guide 60 can be connected to the first flow guide 50 while suppressing the influence on the main flow of the steam S separated from the end portion 52 of the first flow guide 50 on the axial downstream side.

The present disclosure is not limited to the above-described embodiments and embodiments to be described later, and also includes a form in which the above-described embodiments and embodiments to be described later are modified, and a form in which these forms are appropriately combined.

For example, contents described in each of the above-described embodiments are understood as follows.

(1A) The exhaust hood 25 of the steam turbine 1 according to at least one embodiment of the present disclosure includes a diffuser 26 that forms a diffuser space 26s into which steam S flowing out from a last rotor blade row 13e of a steam turbine rotor (turbine rotor 11) rotating around an axis AX flows and which has an annular shape with respect to the axis AX and that gradually expands outward in a radial direction with respect to the axis AX toward an axial downstream side; and an exhaust casing 30 that has an exhaust port 31 opening outward in the radial direction and that forms an exhaust space 30s communicating with the diffuser space 26s and expanding in a circumferential direction with respect to the axis AX to guide the steam S flowing in from the diffuser space 26s to the exhaust port 31. The diffuser 26 includes an outer diffuser 27 having an annular shape in a cross section perpendicular to the axis AX, gradually expanding outward in the radial direction toward the axial downstream side, and defining an edge of the diffuser space 26s on a radial outer side, and an inner diffuser 29 having an annular shape in a cross section perpendicular to the axis AX, gradually expanding outward in the radial direction toward the axial downstream side, and defining an edge of the diffuser space 26s on a radial inner side with respect to the axis AX. The outer diffuser 27 includes a first flow guide 50 extending toward the axial downstream side from a position P facing a blade end 13t of a last stage rotor blade 13be constituting a last rotor blade row 13e, and a second flow guide 60 extending outward in the radial direction from the first flow guide 50 at an angle different from the first flow guide 50.

The first flow guide 50 satisfies at least one of the following conditions.

An axial distance L1 with respect to the axis AX from an end portion 13td of the blade end 13t of the last stage rotor blade 13be on the axial downstream side to the end portion 52 of the first flow guide 50 on the axial downstream side is 20% or more and 45% or less of a blade height h of the last stage rotor blade 13be.

An axial distance L2 from the end portion 52 of the first flow guide 50 on the axial downstream side to a downstream wall surface (casing downstream-side end plate 32) defining an edge of the exhaust space 30s on the axial downstream side in the exhaust casing 30 is 100% or more and 150% or less of the blade height la.

A radial distance L3 with respect to the axis AX from the end portion 51 of the first flow guide 50 on the axial upstream side to the end portion 52 of the first flow guide 50 on the axial downstream side is 200% or more and 300% or less of a radial distance LA from an intersection position (downstream-side intersection position PI) at which a perpendicular line (downstream-side perpendicular line Lpel) extending in a direction perpendicular to the axial direction from the end portion 52 of the first flow guide 50 on the axial downstream side as a start point intersects the inner diffuser 29 to an end portion 29a of the inner diffuser 29 on the axial upstream side.

An area of a cross section CSI of the diffuser space 26s perpendicular to the axis AX at the end portion 52 of the first flow guide 50 on the axial downstream side is 110% or more and 150% or less of an area of a cross section CS2 of the diffuser space 26s perpendicular to the axis AX at an outlet of a last rotor blade row 13e.

According to the configuration of (1A) above, the efficiency of the steam turbine 1 during the partial load operation can be suppressed from being lowered by the first flow guide 50 having a relatively simple configuration while maintaining the efficiency of the steam turbine 1 during the rated operation.

(2A) In some embodiments, in the configuration of (1A) above, the shape of the cross section of the first flow guide 50 appearing on an imaginary plane (for example, a plane in FIGS. 1 to 4) extending in the axial direction and the radial direction may have a curved surface that is convex inward in the radial direction.

According to the configuration of (2A) above, the steam S flowing along the surface 50a of the first flow guide 50 is likely to spread to the radial outer side. Therefore, the pressure loss of the steam S flowing through the diffuser space 26s can be reduced.

(3A) In some embodiments, in the configuration of (1A) or (2A), a distance L5 from an end portion 61 of the second flow guide 60 on the radial inner side to an end portion 62 of the second flow guide 60 on the radial outer side may be 25% or more and 75% or less of a radial distance L6 from the end portion 52 of the first flow guide 50 on the axial downstream side to a radial outer wall surface (casing outer peripheral plate 36) that defines an edge of the exhaust space 30s on the radial outer side in the exhaust casing 30.

According to the configuration of (3A) above, the flow of the steam S that forms a vortex in the exhaust space 30s axially upstream of the second flow guide 60 is less likely to affect the main flow of the steam S flowing along the first flow guide 50. Therefore, the pressure loss inside the exhaust hood 25 can be suppressed.

(4A) In some embodiments, in any one of the configurations of (1A) to (3A), a region 60o on the radial outer side in the second flow guide 60 may be curved toward the axial upstream side as the region 60o extends outward in the radial direction.

According to the configuration of (4A) above, the flow of the steam S that forms a vortex in the exhaust space 30s axially upstream of the second flow guide 60 is less likely to affect the main flow of the steam S flowing along the first flow guide 50. Therefore, the pressure loss inside the exhaust hood 25 can be suppressed.

(5A) In some embodiments, in any one of the configurations of (1A) to (4A), an end portion 61 of the second flow guide 60 on the radial inner side may be connected to the first flow guide 50 at the end portion 52 of the first flow guide 50 on the axial downstream side.

According to the configuration of (5A) above, the second flow guide 60 can be connected to the first flow guide 50 while suppressing the influence on the main flow of the steam S separated from the end portion 52 of the first flow guide 50 on the axial downstream side.

(6A) In some embodiments, in any one of the configurations of (1A) to (4A). an end portion 61 of the second flow guide 60 on the radial inner side may be connected to the first flow guide 50 axially upstream of the end portion 52 of the first flow guide 50 on the axial downstream side.

According to the configuration of (6A) above, the second flow guide 60 can be connected to the first flow guide 50 while suppressing the influence on the main flow of the steam S separated from the end portion 52 of the first flow guide 50 on the axial downstream side.

(7A) In some embodiments, in any one of the configurations of (1A) to (6A), a pipe (spray pipe 38) through which fluid flows, the pipe being disposed in an annular shape in a region that is on the radial outer side of the first flow guide 50 and on the radial inner side of an end portion 62 of the second flow guide 60 on the radial outer side, the region being within a range in the axial direction from an end portion 51 of the first flow guide 50 on the axial upstream side to the end portion 52 of the first flow guide 50 on the axial downstream side may be provided.

According to the configuration of (7A) above, the pipe through which the fluid flows can be disposed while suppressing the influence on the flow of the steam S.

(8A) The steam turbine 1 according to at least one embodiment of the present disclosure includes the exhaust hood 25 of the steam turbine 1 having any one of the configurations of (1A) to (7A) and a steam turbine rotor (turbine rotor 11).

According to the configuration of (8A) above, it is possible to suppress a decrease in the efficiency of the steam turbine 1 during the partial load operation while maintaining the efficiency of the steam turbine 1 during the rated operation.

As a result of further studies by the inventors regarding the above-described embodiment, it has been found that when each of the conditions including a condition (e) described below is satisfied, the efficiency of the steam turbine 1 during partial load operation can be further improved compared to the related art while maintaining the efficiency of the steam turbine 1 during rated operation.

For example, it has been found that the efficiency of the steam turbine 1 during partial load operation can be further improved compared to the related art while maintaining the efficiency of the steam turbine 1 during rated operation by configuring the diffuser 26 according to some embodiments shown in FIGS. 1 to 4 to satisfy the following condition (e).

Here, as shown in FIG. 8, a radial distance from an intersection position (upstream-side intersection position) P2 where a perpendicular line (upstream-side perpendicular line) Lpe2 extending toward the radial outer side in the direction perpendicular to the axial direction from an end portion 29a of the inner diffuser 29 on the axial upstream side as a start point intersects the first flow guide 50 to the end portion 52 of the first flow guide 50 on the axial downstream side is defined as a distance LS. The end portion 29a of the inner diffuser 29 on the axial upstream side that defines the upstream-side perpendicular line Lpe2 is an end portion of the surface of the inner diffuser 29 facing the diffuser space 26s. The upstream-side intersection position P2 defining the distance L8 and the end portion 52 of the first flow guide 50 on the axial downstream side are located on the surface of the first flow guide 50 facing the diffuser space 26s. In addition, the end portion 52 of the first flow guide 50 on the axial downstream side, which defines the distance L1, the distance L3, the distance L5, and the distance L7, is also located on the surface of the first flow guide 50 facing the diffuser space 26s.

As described above, the distance L4 is a radial distance from a downstream-side intersection position PI where a perpendicular line (downstream-side perpendicular line) Lpel extending toward the radial inner side in the direction perpendicular to the axial direction from the end portion 52 of the first flow guide 50 on the axial downstream side as a start point intersects the inner diffuser 29 to the end portion 29a of the inner diffuser 29 on the axial upstream side. In addition, the end portion 52 of the first flow guide 50 on the axial downstream side, which defines the downstream-side perpendicular line Lpel, is also located on the surface of the first flow guide 50 facing the diffuser space 26s. The downstream-side intersection position PI defining the distance LA is located on the surface of the inner diffuser 29 facing the diffuser space 26s. An end portion 29a of the inner diffuser 29 that defines the distance L4 and that is on the axial upstream side is an end portion of a surface of the inner diffuser 29 facing the diffuser space 26s.

An axial distance from the upstream-side intersection position P2 to the end portion 52 of the first flow guide 50 on the axial downstream side is defined as a distance L7.

The distance L7 is also an axial distance from the upstream-side perpendicular line Lpe2 to the downstream-side perpendicular line Lpel.

In addition, the upstream-side perpendicular line Lpe2 and the downstream-side perpendicular line Lpel are perpendicular lines appearing on an imaginary plane (for example, a plane in FIG. 8) extending in the axial direction and the radial direction.

Condition (e) is as follows.
(e) A value obtained by subtracting the distance L4 from the distance L8 (L8 L4) is 35% or more and 70% or less of the distance L7, that is, 35% ≤((L8−L4)/L7)≤70%.

In this manner, the efficiency of the steam turbine 1 during the partial load operation can be further improved compared to the related art while maintaining the efficiency of the steam turbine 1 during the rated operation.

Hereinafter, a reason why the efficiency of the steam turbine 1 during the partial load operation can be further improved compared to the related art while maintaining the efficiency of the steam turbine 1 during the rated operation by satisfying the condition (e) will be described.

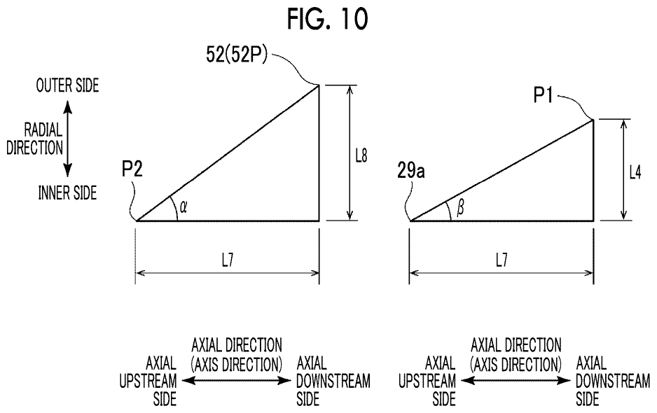

FIG. 10 is a diagram for describing an angle a formed by a line segment connecting the upstream-side intersection position P2 and the end portion 52 of the first flow guide 50 on the axial downstream side with respect to the axial direction, and an angle β formed by a line segment connecting the end portion 29a of the inner diffuser 29 on the axial upstream side and the downstream-side intersection position P1 with respect to the axial direction.

Here, the angle difference (α−β) between the angle α and the angle β is an angle corresponding to an opening angle θ between the first flow guide 50 and the inner diffuser 29 in the diffuser 26.

In general, in a diffuser (hereinafter, simply referred to as a diffuser) provided in the last rotor blade row 13e or after of the steam turbine, when the opening angle 0 is made too large, the steam is separated from the diffuser, particularly during operation of the steam turbine at a relatively high load. Therefore, the opening angle θ of the diffuser is not set to be too large.

For example, during operation under a relatively high load as in the case of the rated operation, the steam S flows over the entire region in the diffuser space 26s between the first flow guide 50 and the inner diffuser 29 as shown in FIG. 5, for example. However, during operation under a relatively low load, for example, a circulation flow is generated to flow from the radial outer side toward the radial inner side on the axial downstream side as in a region Rc surrounded by a broken line in FIG. 6. Therefore, the steam S that has flowed into the diffuser space 26s from the last rotor blade row 13e flows in a region axially upstream of the region Re due to the influence of the circulation flow.

Therefore, by increasing the opening angle 0, the steam S that has flowed into the diffuser space 26s from the last rotor blade row 13e can be made to flow more easily.

However, in a case where the first flow guide 50 does not have the separation point 52P, as described in the above-described embodiment, the flow of the steam S flowing along the surface 50a of the first flow guide 50 generates a flow having a relatively high flow speed in the vicinity of the surface 50a of the first flow guide 50 due to the Coanda effect, and the exhaust space 30s is divided into a region on the axial upstream side and a region on the axial downstream side with the flow of the steam S as a boundary, so that the pressure recovery in the exhaust space 30s is suppressed.

Therefore, in some embodiments, in order to promote the separation of the steam S from the surface 50a of the first flow guide 50 and to reduce the above-described Coanda effect, the first flow guide 50 is provided with the separation point 52P, and the opening angle θ is increased.

Here, increasing the opening angle θ will be further described. As described above, the opening angle θ corresponds to the angle difference (α−β) between the angle α and the angle β. As the angle difference (α−β) increases, the difference between tan α, that is, L8/L7 and tan B, that is, L4/L7, namely tan α−tan β, that is, (L8−L4)/L7, increases. Therefore, tanα−tanβ, that is, (L8−L4)/L7 can be used as an index of the magnitude of the opening angle θ.

Therefore, the above-described condition (e) is a condition regarding the magnitude of the opening angle θ.

In this way, in the exhaust hood 25 according to some embodiments, the end portion 52 of the first flow guide 50 on the axial downstream side is the separation point 52P. In the exhaust hood 25 according to some embodiments, the diffuser 26 is configured to satisfy the above condition (e).

In this manner, the efficiency of the steam turbine 1 during the partial load operation can be further improved compared to the related art.

The physical meaning of (L8−L4)/L7 under the above condition (e) is the opening angle θ of the diffuser, and is a quantity representing an area ratio of the diffuser (that is, a ratio between a flow path area on the upstream side of the diffuser and a flow path area on the downstream side of the diffuser) and a length ratio (that is, the ratio between the length of the diffuser and the representative length).

The numerical range of (L8−L4)/L7 under the above condition (e) is set so that the steam S does not separate from the surface 50a of the first flow guide 50. (L8−L4)/L7 is preferably larger within a range where the steam S does not separate from the surface 50a of the first flow guide 50.

In the numerical range of (L8−L4)/L7, 70% which is the upper limit value is set, as described above, so that the steam S does not separate from the surface 50a of the first flow guide 50. That is, when (L8−L4)/L7 exceeds 70% of the distance L7, the probability that the steam S separates from the surface 50a of the first flow guide 50 relatively rapidly increases.

In addition, 35% which is the lower limit value of (L8−L4)/L7 under the above condition (e) is the lower limit value of a numerical value necessary for the appearance of the diffuser effect in the diffuser space 26s between the first flow guide 50 and the inner diffuser 29. When (L8−L4)/L7 is less than 35% of the distance L7, the effect of restraining the flow of the steam S from being directed to the radial outer side by the first flow guide 50 is increased, and there is a concern that the diffuser effect may not be exhibited.

From the viewpoint of the efficiency of the steam turbine 1, it is more preferable that the numerical range of (L8−L4)/L7 is 40% or more and 60% or less of the distance L7.

### (Regarding Distance L1)

In addition, when the opening angle θ is made too large, there is a concern that the steam may be separated from the diffuser during operation with a relatively high load, and the efficiency of the steam turbine 1 may be significantly impaired.

Therefore, in some embodiments, the axial distance L1 from the end portion 13td of the blade end 13t of the last stage rotor blade 13be on the axial downstream side to the end portion 52 of the first flow guide 50 on the axial downstream side is set to be relatively short.

Accordingly, as shown in FIG. 5, during the rated operation, the main flow of the steam S separated from the end portion 52 of the first flow guide 50 on the axial downstream side becomes a free jet-like flow, and the same effect as that in a case where a diffuser is present on the axial downstream side from the end portion 52 of the first flow guide 50 is obtained. Therefore, even when the distance L1 is relatively short, the efficiency of the steam turbine 1 during the rated operation can be maintained.

Specifically, in some embodiments, in a case where the above condition (e) is satisfied, the axial distance L1 from an end portion 13td of the blade end 13t of the last stage rotor blade 13be on the axial downstream side to the end portion 52 of the first flow guide 50 on the axial downstream side may be 20% or more and 40% or less of a blade height h of the last stage rotor blade 13be.

In this manner, the efficiency of the steam turbine 1 during operation under a relatively high load can be maintained at a relatively high efficiency.

The physical meaning of the distance L1 is the length of the diffuser. It is desirable that the distance L1 is short.

The distance L1 is related to the numerical range of (L8−L4)/L7 in the condition (e) described above, and it is desirable to obtain a sufficient area ratio within a range where delamination does not occur at a short distance.

The 20% of the lower limit value of the distance L1 is a value set from such a viewpoint.

When the steam S is separated in the diffuser, the effective area of the diffuser is reduced.

When the distance L1 is long, the distance at which the wall surface of the diffuser and the flow of the steam S come into contact with each other becomes long, and the frictional loss between the wall surface of the diffuser and the flow of the steam S becomes large.

The 40% of the upper limit value of the distance L1 is a value set from such a viewpoint.

From the viewpoint of the efficiency of the steam turbine 1, it is more preferable that the numerical range of the distance L1 is 30% or more and 40% or less of the blade height h of the last stage rotor blade 13be.

### (Regarding Distance L2)

The physical meaning of the distance L2 described above is a parameter corresponding to an outlet length of the diffuser. It is desirable that the distance L2 is as large as possible.

In consideration of the above-described length ratio, it is desirable to secure the effective area of the diffuser to an extent that the steam S is not separated inside the diffuser.

As described above, the distance L2 is preferably large, but when the distance L2 is too large, the steam S is separated inside the diffuser, and the effective area of the diffuser is reduced.

In addition, when the distance L2 is too small, the diffuser does not function.

From this viewpoint, in a case where the above condition (e) is satisfied, the distance L2 may be 120% or more and 145% or less of the blade height h.

Accordingly, the efficiency of the steam turbine 1 during the partial load operation can be further improved compared to the related art, and the efficiency of the steam turbine 1 during the operation at a relatively high load can be maintained at a relatively high efficiency.

From the viewpoint of the efficiency of the steam turbine 1, it is more preferable that the numerical range of the distance L2 is 130% or more and 140% or less of the blade height li.

### (Regarding Area of Cross Section of Diffuser Space 26s Perpendicular to Axial Direction)

An annular cross section of the diffuser space 26s at the end portion 29a of the inner diffuser 29 on the axial upstream side, which is perpendicular to the axis AX, is defined as a cross section CS3. The cross section CS2 described above is an anular cross section perpendicular to the axis AX of the diffuser space 26s at the outlet of the last rotor blade row 13e. However, since the positions of the cross section CS3 and the cross section CS2 in the axial direction are extremely close to each other, they are shown at the same position in FIG. 9. The end portion 29a of the inner diffuser 29 that is on the axial upstream side and that defines the cross section CS3 is an end portion of the surface of the inner diffuser 29 facing the diffuser space 26s.

In a case where the above condition (e) is satisfied, the area of the cross section CS1 described above, that is, the area of the annular cross section CS1 of the diffuser space 26s perpendicular to the axis AX at the end portion 52 of the first flow guide 50 on the axial downstream side may be 140% or more and 180% or less of an area of the cross section CS3.

The above-described range of “140% or more and 180% or less” is a range set so that the steam S is not separated inside the diffuser 26.

Accordingly, the efficiency of the steam turbine 1 during the partial load operation can be further improved compared to the related art, and the efficiency of the steam turbine 1 during the operation at a relatively high load can be maintained at a relatively high efficiency.

In addition, the end portion 52 of the first flow guide 50 on the axial downstream side defining the cross section CSI is also located on the surface facing the diffuser space 26s of the first flow guide 50.

From the viewpoint of the efficiency of the steam turbine 1, the area of the cross section CS1 is more preferably 155% or more and 165% or less of the area of the cross section CS3.

### (Regarding Distance L5 and Distance L6)

When the distance L5 from the end portion 61 on the radial inner side to the end portion 62 of the second flow guide 60 on the radial outer side is too long, the steam S is less likely to be supplied to the exhaust space 30s of the second flow guide 60 on the axial upstream side. However, when the distance L5 is too short, the flow of the steam S that forms a vortex in the exhaust space 30s axially upstream of the second flow guide 60 easily affects the main flow of the steam S flowing along the first flow guide 50. Therefore, the pressure loss inside the exhaust hood 25 increases.

From this viewpoint, in a case where the above condition (e) is satisfied, a distance LS from the end portion 61 on the radial inner side to the end portion 62 of the second flow guide 60 on the radial outer side may be 25% or more and 75% or less of a radial distance L6 from the end portion 52 of the first flow guide 50 on the axial downstream side to a radial outer wall surface (casing outer peripheral plate 36) that defines the edge of the exhaust space 30s on the radial outer side inside the exhaust casing 30.

Accordingly, the flow of the steam S that forms a vortex in the exhaust space 30s axially upstream of the second flow guide 60 is less likely to affect the main flow of the steam S flowing along the first flow guide 50. Therefore, the pressure loss inside the exhaust hood 25 can be suppressed.

For example, contents described in each of the above-described embodiments are understood as follows.

(1B) The exhaust hood 25 of the steam turbine 1 according to at least one embodiment of the present disclosure includes a diffuser 26 that forms a diffuser space 26s into which steam S flowing out from a last rotor blade row 13e of a steam turbine rotor (turbine rotor 11) rotating around an axis AX flows and which has an annular shape with respect to the axis AX and that gradually expands outward in a radial direction with respect to the axis AX toward an axial downstream side; and an exhaust casing 30 that has an exhaust port 31 opening outward in the radial direction and that forms an exhaust space 30s communicating with the diffuser space 26s and expanding in a circumferential direction with respect to the axis AX to guide the steam S flowing in from the diffuser space 26s to the exhaust port 31. The diffuser 26 includes an outer diffuser 27 having an annular shape in a cross section perpendicular to the axis AX, gradually expanding outward in the radial direction toward the axial downstream side, and defining an edge of the diffuser space 26s on a radial outer side, and an inner diffuser 29 having an annular shape in a cross section perpendicular to the axis AX, gradually expanding outward in the radial direction toward the axial downstream side, and defining an edge of the diffuser space 26s on a radial inner side with respect to the axis AX. The outer diffuser 27 includes a first flow guide 50 extending toward the axial downstream side from a position P facing a blade end 13t of a last stage rotor blade 13be constituting a last rotor blade row 13e, and a second flow guide 60 extending outward in the radial direction from the first flow guide 50 at an angle different from the first flow guide 50.

An end portion 52 of the first flow guide 50 on the axial downstream side is a separation point 52P formed such that a flow of the steam S flowing through the diffuser space 26s separates from the end portion 52 on the axial downstream side. A value obtained by subtracting a radial distance L4, measured from a downstream-side intersection position PI where a downstream-side perpendicular line Lpel extending inward in the radial direction from the end portion 52 of the first flow guide 50 on the axial downstream side as a start point in a direction perpendicular to an axial direction with respect to the axis AX intersects the inner diffuser 29 to an end portion 29a of the inner diffuser 29 on an axial upstream side, from a radial distance LS, measured from an upstream-side intersection position P2 where an upstream-side perpendicular line Lpe2 extending outward in the radial direction from the end portion 29a of the inner diffuser 29 on the axial upstream side as a start point in a direction perpendicular to the axial direction intersects the first flow guide 50 to the end portion 52 of the first flow guide 50 on the axial downstream side, is 35% or more and 70% or less of an axial distance L7 from the upstream-side intersection position P2 to the end portion 52 of the first flow guide 50 on the axial downstream side.

According to the configuration of (1B) above, the efficiency of the steam turbine 1 during the partial load operation can be further improved compared to the related art by the first flow guide 50 having a relatively simple configuration.

(2B) In some embodiments, in the configuration of (1B), an axial distance L1 with respect to the axis AX from an end portion 13td of the blade end 13t of the last stage rotor blade 13be on the axial downstream side to the end portion 52 of the first flow guide 50 on the axial downstream side may be 20% or more and 40% or less of a blade height h of the last stage rotor blade 13be.

According to the configuration of (2B) above, the efficiency of the steam turbine 1 during operation under a relatively high load can be maintained at a relatively high efficiency.

(3B) In some embodiments, in the configuration of (1B) or (2B), an axial distance L2 from the end portion 52 of the first flow guide 50 on the axial downstream side to a downstream wall surface (casing downstream-side end plate 32) defining an edge of the exhaust space 30s on the axial downstream side in the exhaust casing 30 may be 120% or more and 145% or less of a blade height h.

According to the configuration of (3B) above, the efficiency of the steam turbine 1 during the partial load operation can be further improved compared to the related art, and the efficiency of the steam turbine 1 during the operation at a relatively high load can be maintained at a relatively high efficiency.

(4B) In some embodiments, in any one of the configurations of (1B) to (3B), an area of a cross section CS1 of the diffuser space 26s perpendicular to the axis AX at the end portion 52 of the first flow guide 50 on the axial downstream side may be 140% or more and 180% or less of an area of a cross section CS3 of the diffuser space 26s perpendicular to the axis AX at an end portion 29a of the inner diffuser 29 on the axial upstream side.

According to the configuration of (4B) above, the efficiency of the steam turbine 1 during the partial load operation can be further improved than in the related art, and the efficiency of the steam turbine 1 during the operation at a relatively high load can be maintained at a relatively high efficiency.

(5B) In some embodiments, in any one of the configurations of (1B) to (4B), a distance L5 from an end portion 61 of the second flow guide 60 on the radial inner side to an end portion 62 of the second flow guide 60 on the radial outer side may be 25% or more and 75% or less of a radial distance L6 from the end portion 52 of the first flow guide 50 on the axial downstream side to a radial outer wall surface (casing outer peripheral plate 36) that defines an edge of the exhaust space 30s on the radial outer side in the exhaust casing 30.

According to the configuration of (5B) above, the flow of the steam S that forms a vortex in the exhaust space 30s axially upstream of the second flow guide 60 is less likely to affect the main flow of the steam S flowing along the first flow guide 50. Therefore, the pressure loss inside the exhaust hood 25 can be suppressed.

(6B) In some embodiments, in any one of the configurations of (1B) to (5B), a shape of a cross section of the first flow guide 50 appearing on an imaginary plane (for example, a plane in FIGS. 1 to 4) extending in the axial direction and the radial direction may have a curved surface that is convex inward in the radial direction.

According to the configuration of (6B) above, the steam S flowing along the surface 50a of the first flow guide 50 is likely to spread to the radial outer side. Therefore, the pressure loss of the steam S flowing through the diffuser space 26s can be reduced.

(7B) In some embodiments, in any one of the configurations of (1B) to (6B), a region 60o on the radial outer side in the second flow guide 60 may be curved toward the axial upstream side as the region 60o extends outward in the radial direction.

According to the configuration of (7B) above, the flow of the steam S that forms a vortex in the exhaust space 30s axially upstream of the second flow guide 60 is less likely to affect the main flow of the steam S flowing along the first flow guide 50. Therefore, the pressure loss inside the exhaust hood 25 can be suppressed.

(8B) In some embodiments, in any one of the configurations of (1B) to (7B), an end portion 61 of the second flow guide 60 on the radial inner side may be connected to the first flow guide 50 at the end portion 52 of the first flow guide 50 on the axial downstream side.

According to the configuration of (8B) above, the second flow guide 60 can be connected to the first flow guide 50 while suppressing the influence of the main flow of the steam S separated from the end portion 52 of the first flow guide 50 on the axial downstream side.

(9B) In some embodiments, in any one of the configurations of (1B) to (7B), an end portion 61 of the second flow guide 60 on the radial inner side may be connected to the first flow guide 50 axially upstream of the end portion 52 of the first flow guide 50 on the axial downstream side.

According to the configuration of (9B) above, the second flow guide 60 can be connected to the first flow guide 50 while suppressing the influence on the main flow of the steam S separated from the end portion 52 of the first flow guide 50 on the axial downstream side.

(10B) In some embodiments, in any one of the configurations of (1B) to (9B), a pipe (spray pipe 38) through which fluid flows, the pipe being disposed in an annular shape in a region that is on the radial outer side of the first flow guide 50 and on the radial inner side of an end portion 62 of the second flow guide 60 on the radial outer side, the region being within a range in the axial direction from an end portion 51 of the first flow guide 50 on the axial upstream side to the end portion 52 of the first flow guide 50 on the axial downstream side may be provided.

According to the configuration of (10B) above, the pipe through which the fluid flows can be disposed while suppressing the influence on the flow of the steam S.

(11B) The steam turbine 1 according to at least one embodiment of the present disclosure includes the exhaust hood 25 of a steam turbine 1 according to any one of the configurations of (1B) to (10B), and a steam turbine rotor (turbine rotor 11).

According to the configuration of (11B) above, the efficiency of the steam turbine 1 during the partial load operation can be further improved compared to the related art.

### REFERENCE SIGNS LIST

1: steam turbine
11: turbine rotor (steam turbine rotor)
13: rotor blade row
13b: rotor blade
13be: last stage rotor blade
13e: last rotor blade row
13t: blade end
13td: end portion
20: casing
21: inner casing
25: exhaust hood
26: diffuser
26s: diffuser space
27: outer diffuser (steam guide, flow guide)
29: inner diffuser (bearing cone)
29a: end portion
30: exhaust casing
30s: exhaust space
31: exhaust port
32: casing downstream-side end plate
36: casing outer peripheral plate
38: spray pipe
50: first flow guide
50a: surface
51: end portion
52: end portion
60: second flow guide
60i: region
60o: region
61: end portion
62: end portion

1.A steam turbine exhaust hood, comprising:
a diffuser that forms a diffuser space into which steam flowing out from a last rotor blade row of a steam turbine rotor rotating around an axis flows and which has an annular shape with respect to the axis and that gradually expands outward in a radial direction with respect to the axis toward an axial downstream side; and
an exhaust casing that has an exhaust port opening outward in the radial direction and that forms an exhaust space communicating with the diffuser space and expanding in a circumferential direction with respect to the axis to guide the steam flowing in from the diffuser space to the exhaust port,
wherein the diffuser includes
an outer diffuser having an annular shape in a cross section perpendicular to the axis, gradually expanding outward in the radial direction toward the axial downstream side, and defining an edge of the diffuser space on a radial outer side, and
an inner diffuser having an annular shape in a cross section perpendicular to the axis, gradually expanding outward in the radial direction toward the axial downstream side, and defining an edge of the diffuser space on a radial inner side with respect to the axis,
the outer diffuser includes
a first flow guide extending toward the axial downstream side from a position facing a blade end of a last stage rotor blade constituting a last rotor blade row, and
a second flow guide extending outward in the radial direction from the first flow guide at an angle different from the first flow guide,
an end portion of the first flow guide on the axial downstream side is a separation point formed such that a flow of the steam flowing through the diffuser space separates from the end portion on the axial downstream side, and
a value obtained by subtracting a radial distance, measured from a downstream-side intersection position where a downstream-side perpendicular line extending inward in the radial direction from the end portion of the first flow guide on the axial downstream side as a start point in a direction perpendicular to an axial direction with respect to the axis intersects the inner diffuser to an end portion of the inner diffuser on an axial upstream side, from a radial distance, measured from an upstream-side intersection position where an upstream-side perpendicular line extending outward in the radial direction from the end portion of the inner diffuser on the axial upstream side as a start point in a direction perpendicular to the axial direction intersects the first flow guide to the end portion of the first flow guide on the axial downstream side, is 35% or more and 70% or less of an axial distance from the upstream-side intersection position to the end portion of the first flow guide on the axial downstream side.

2. The steam turbine exhaust hood according to claim 1,
wherein an axial distance with respect to the axis from an end portion of the blade end of the last stage rotor blade on the axial downstream side to the end portion of the first flow guide on the axial downstream side is 20% or more and 40% or less of a blade height of the last stage rotor blade.

3. The steam turbine exhaust hood according to claim 1,
wherein an axial distance from the end portion of the first flow guide on the axial downstream side to a downstream wall surface defining an edge of the exhaust space on the axial downstream side in the exhaust casing is 120% or more and 145% or less of the blade height.

4. The steam turbine exhaust hood according to claim 1,
wherein an area of a cross section of the diffuser space perpendicular to the axis at the end portion of the first flow guide on the axial downstream side is 140% or more and 180% or less of an area of a cross section of the diffuser space perpendicular to the axis at an end portion of the inner diffuser on the axial upstream side.

5. The steam turbine exhaust hood according to claim 1,
wherein a distance from an end portion of the second flow guide on the radial inner side to an end portion of the second flow guide on the radial outer side is 25% or more and 75% or less of a radial distance from the end portion of the first flow guide on the axial downstream side to a radial outer wall surface that defines an edge of the exhaust space on the radial outer side in the exhaust casing.

6. The steam turbine exhaust hood according to claim 1,
wherein a shape of a cross section of the first flow guide appearing on an imaginary plane extending in the axial direction and the radial direction has a curved surface that is convex inward in the radial direction.

7. The steam turbine exhaust hood according to claim 1,
wherein a region on the radial outer side in the second flow guide is curved toward the axial upstream side as the region extends outward in the radial direction.

8. The steam turbine exhaust hood according to claim 1,
wherein an end portion of the second flow guide on the radial inner side is connected to the first flow guide at the end portion of the first flow guide on the axial downstream side.

9. The steam turbine exhaust hood according to claim 1,
wherein an end portion of the second flow guide on the radial inner side is connected to the first flow guide axially upstream of the end portion of the first flow guide on the axial downstream side.

10. The steam turbine exhaust hood according to claim 1, further comprising:
a pipe through which fluid flows, the pipe being disposed in an annular shape in a region that is on the radial outer side of the first flow guide and on the radial inner side of an end portion of the second flow guide on the radial outer side, the region being within a range in the axial direction from an end portion of the first flow guide on the axial upstream side to the end portion of the first flow guide on the axial downstream side.

11. A steam turbine comprising:
the steam turbine exhaust hood according to claim 1; and
a steam turbine rotor.
